(19) United States
(12) Patent Application Publication
(10) Pub. No.: US 2026/0109304 A1
(43) Pub. Date: Apr. 23, 2026

(54) WIRE HARNESS

(71) Applicants: SUMITOMO WIRING SYSTEMS, LTD., Yokkaichi-shi (JP); TOYOTA JIDOSHA KABUSHIKI KAISHA, Toyota-shi (JP)

(72) Inventors: Yuji OKAMOTO, Yokkaichi-shi (JP); Masao Suzuki, Yokkaichi-shi (JP); Hideki Hattori, Yokkaichi-shi (JP); Atsushi Ono, Yokkaichi-shi (JP); Toru Kawamiya, Yokkaichi-shi (JP); Toshiaki Ueno, Yokkaichi-shi (JP); Shota Morikawa, Yokkaichi-shi (JP); Kazuhiro Minamitani, Toyota-shi (JP); Kouichi Hiratsuka, Toyota-shi (JP)

(73) Assignees: SUMITOMO WIRING SYSTEMS, LTD., Yokkaichi-shi (JP); TOYOTA JIDOSHA KABUSHIKI KAISHA, Toyota-shi (JP)

(21) Appl. No.: 19/352,108

(22) Filed: Oct. 7, 2025

(30) Foreign Application Priority Data
Oct. 17, 2024 (JP) 2024-181822

(51) Int. Cl. B60R 16/02; H02G 3/04

(52) U.S. Cl. CPC B60R 16/0215; H02G 3/0418; H02G 3/0437

(57) ABSTRACT

A wire harness includes an electric wire bundle including multiple electric wires, a protector body that holds the electric wire bundle, and a connector provided in an upward direction with respect to the protector body and configured to be fitted to a mating connector from a first direction. The protector body includes a main body portion and a cover portion. The main body portion includes a connecting portion that opens in the upward direction. The electric wires are connected to an end in the first opposite direction of the connector through the connecting portion. The cover portion includes a rear covering portion and an upper covering portion. The rear covering portion covers a side in the first opposite direction of the electric wires. The upper covering portion covers a side in the upward direction of the electric wires.

### CROSS-REFERENCE TO RELATED APPLICATIONS

This application is based upon and claims the benefit of priority from Japanese Patent Application No. 2024-181822, filed on Oct. 17, 2024, the entire contents of which are incorporated herein by reference.

### BACKGROUND

### 1. Field

The present disclosure relates to a wire harness.

### 2. Description of Related Art

A typical wire harness includes an electric wire bundle including multiple electric wires and a connector. In some configurations, the wire harness further includes a wire cover that covers multiple electric wires connected to the rear end of the connector (see, for example, JP2019-179619A). In such a wire harness, the wire cover protects the electric wires that extend rearward from the connector.

However, a wire harness of the type described above requires a dedicated wire cover, resulting in an increased number of components.

It is an objective of the present disclosure to provide a wire harness capable of protecting electric wires while avoiding an increase in the number of components.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a wire harness includes an electric wire bundle including multiple electric wires, a protector body that holds the electric wire bundle, and a connector provided in an upward direction with respect to the protector body and configured to be fitted to a mating connector from a first direction intersecting with the upward direction. The protector body includes a main body portion and a cover portion. The main body portion is provided with an opening that opens in a first opposite direction opposite to the first direction. The electric wire bundle is accommodated in the body portion. The cover portion closes the opening. The main body portion includes a connecting portion that opens in the upward direction. The electric wires extend from within the protector body through the connecting portion to be connected to an end in the first opposite direction of the connector. The cover portion includes a rear covering portion and an upper covering portion. The rear covering portion is located in the upward direction with respect to the connecting portion. The rear covering portion covers a side in the first opposite direction of the electric wires. The upper covering portion covers a side in the upward direction of the electric wires.

The wire harness of the present disclosure is capable of protecting electric wires while avoiding an increase in the number of components.

Other features and aspects will be apparent from the following detailed description, the drawings, and the claims.

### BRIEF DESCRIPTION OF THE DRAWINGS

FIG. 1 is a perspective view of a wire harness and an attachment member according to an embodiment.

FIG. 2 is a perspective view of the wire harness according to the embodiment.

FIG. 3 is a perspective view of a protector and an electric wire bundle according to the embodiment.

FIG. 4 is a front view of the protector and the electric wire bundle according to the embodiment.

FIG. 5 is a transverse cross-sectional view of the wire harness and the attachment member according to the embodiment.

FIG. 6 is a transverse cross-sectional view of the wire harness and the attachment member according to the embodiment.

FIG. 7 is a transverse cross-sectional view of the wire harness and the attachment member according to the embodiment.

FIG. 8 is a plan view showing part of the wire harness according to the embodiment.

FIG. 9 is a perspective view of a cover portion according to the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Description of Embodiment in Accordance with Present Disclosure

An embodiment in accordance with the present disclosure will now be described.

Aspects of a wire harness according to the present disclosure include the following.

[1] A wire harness includes an electric wire bundle including multiple electric wires, a protector body that holds the electric wire bundle, and a connector provided in an upward direction with respect to the protector body and configured to be fitted to a mating connector from a first direction intersecting with the upward direction. The protector body includes a main body portion and a cover portion. The main body portion is provided with an opening that opens in a first opposite direction opposite to the first direction. The electric wire bundle is accommodated in the body portion. The cover portion closes the opening. The main body portion includes a connecting portion that opens in the upward direction. The electric wires extend from within the protector body through the connecting portion to be connected to an end in the first opposite direction of the connector. The cover portion includes a rear covering portion and an upper covering portion. The rear covering portion is located in the upward direction with respect to the connecting portion. The rear covering portion covers a side in the first opposite direction of the electric wires. The upper covering portion covers a side in the upward direction of the electric wires.

According to this configuration, the cover portion, which closes the opening, includes the rear covering portion, which covers the side in the first opposite direction of the electric wires, and the upper covering portion, which covers the side in the upward direction of the electric wires. This configuration covers the multiple electric wires while avoiding an increase in the number of components. In other words, since the cover portion closes the opening that opens in the first opposite direction of the main body portion of the protector body, the number of components is not increased as compared with a configuration that separately includes a dedicated cover member for protecting the electric wires. The rear covering portion prevents foreign matter from striking the electric wires from the first opposite direction. Further, the upper covering portion prevents foreign matter from striking the electric wires from above (from the area in the upward direction).

[2] In item [1], the cover portion may include an inclined portion at an end in the first opposite direction of an upper edge of the cover portion. The inclined portion may extend in the first direction while being inclined obliquely in the upward direction.

According to this configuration, the cover portion includes the inclined portion at the end in the first opposite direction of the upper edge of the cover portion, and the inclined portion extends in the first direction while being inclined obliquely in the upward direction. Therefore, it is possible to guide foreign matter that has struck the end in the first opposite direction of the upper edge of the cover portion from above (from the area in the upward direction) to move in the first opposite direction.

[3] In item [1] or [2], the upper covering portion may extend farther in the first direction than an end in the first opposite direction of the connector.

According to this configuration, the upper covering portion extends farther in the first direction than the end in the first opposite direction of the connector. Therefore, for example, even when the protector body is inclined, it is possible to prevent foreign matter from striking the electric wires from above (from the area in the upward direction). Specifically, for example, in a configuration in which the upper covering portion does not extend farther in the first direction than the end in the first opposite direction of the connector, tilting of the protector body may cause foreign matter from above (from the area in the upward direction) to pass through between the connector and the upper covering portion. The above-described configuration prevents such passage of foreign matter.

[4] In any of items [1] to [3], the upper covering portion may cover all of the electric wires when viewed from a position in the upward direction.

According to this configuration, the upper covering portion covers all of the electric wires when viewed from above (from a position in the upward direction). This prevents foreign matter from striking all the electric wires from above (from the area in the upward direction).

[5] In any of items [1] to [4], the cover portion may include a reinforcing rib extending across the rear covering portion and the upper covering portion.

According to this configuration, the cover portion includes the reinforcing rib, which extends across the rear covering portion and the upper covering portion. Therefore, for example, even when foreign matter strikes the cover portion from above (from the area in the upward direction), the cover portion is unlikely to be deformed. Therefore, the electric wires are reliably protected.

[6] In any of items [1] to [6], the cover portion may be coupled to a lower end of the main body portion by a thin hinge portion so as to be rotatable from an open state to a closed state. The cover portion may close the opening when in the closed state.

According to this configuration, the cover portion is coupled to the lower end of the main body portion by the thin hinge portion so as to be rotatable from the open state to the closed state. Therefore, for example, the number of components is reduced as compared with a case in which the cover portion is a separate component from the main body portion.

### Details of the Embodiment of the Present Disclosure

A specific example of a wire harness in accordance with the present disclosure will now be described with reference to the drawings. In the drawings, elements are shown for illustrative purposes and may be partially exaggerated or omitted. The dimensional ratios of components may differ among the drawings.

In this specification, the terms “first,” “second,” “third,” and the like are used to distinguish subjects and not used for ordinal purposes. The present disclosure is not limited to these examples and is intended to include all modifications described by the scope of claims and corresponding to equivalents of the scope of claims.

### Structure of Wire Harness 10

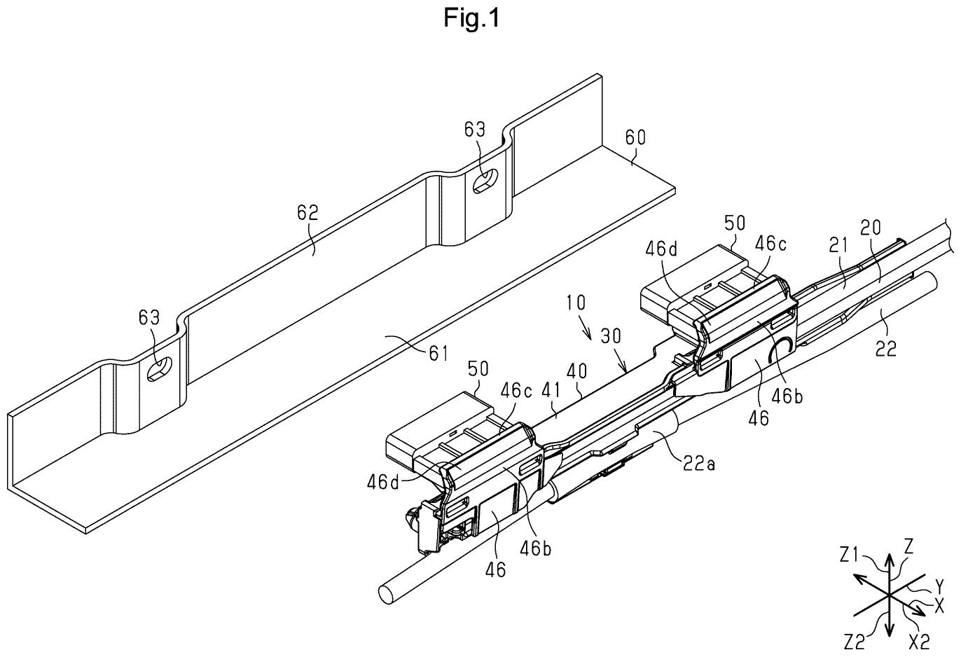

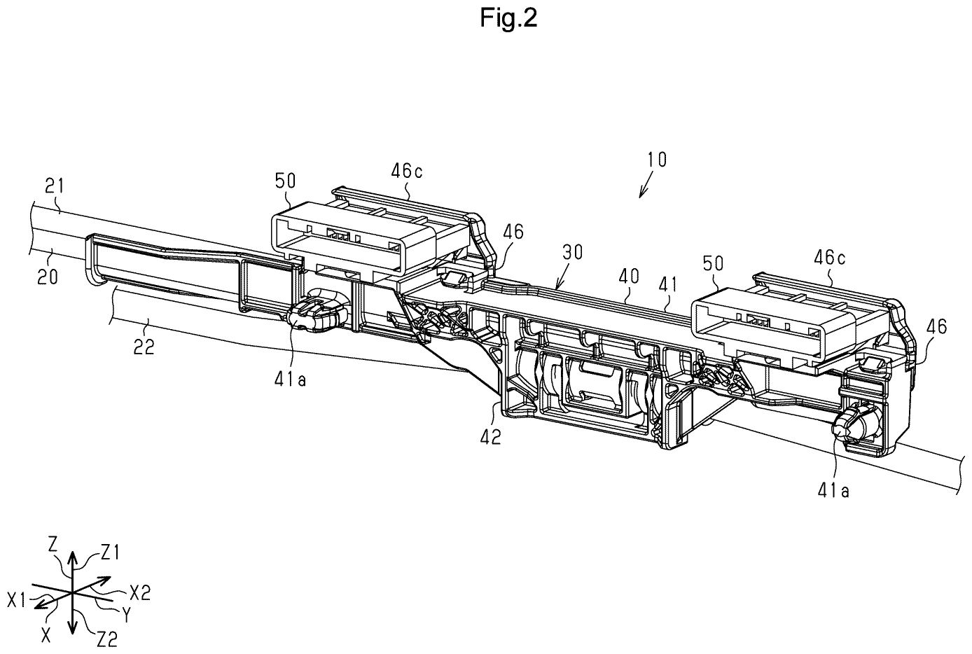

As shown in FIGS. 1 and 2, a wire harness 10 includes two electric wire bundles 20, 21, one additional electric wire bundle 22, and a protector 30. The protector 30 includes a protector component 40 and two connectors 50. For example, the wire harness 10 of the present embodiment is fixed to an attachment member 60 (see FIG. 1) that forms a part of a housing of a battery pack provided in a vehicle (not shown) such as a hybrid electric vehicle or a battery electric vehicle.

In each drawing, a first axis X, a second axis Y orthogonal to the first axis X, and a third axis Z orthogonal to the first axis X and the second axis Y are shown. In addition, in the drawings, a first direction X1, which is one direction along the first axis X, and a first opposite direction X2, which is a direction opposite to the first direction X1 are shown. In addition, in the drawings, an upward direction Z1, which is one direction along the third axis Z, and a downward direction Z2 which is a direction opposite to the upward direction Z1 are shown.

### Configuration of the Attachment Member 60

As shown in FIG. 1, the attachment member 60 includes a plate-shaped bottom wall 61 orthogonal to the third axis Z, and a plate-shaped side wall 62 that extends in the upward direction Z1 from the bottom wall 61 and is orthogonal to the first axis X. The side wall 62 is formed in an elongated shape along the second axis Y, and has two fixing holes 63 at positions away from each other along the second axis Y.

### Configuration of the Protector Component 40

As shown in FIGS. 2 to 5, the protector component 40 includes a protector body 41 and a downward extending portion 42. The protector body 41 and the downward extending portion 42 are integrally molded. The protector body 41 is formed in an elongated shape along the second axis Y so as to hold the elongated electric wire bundles 20, 21 therein.

### Structure of the Connectors 50

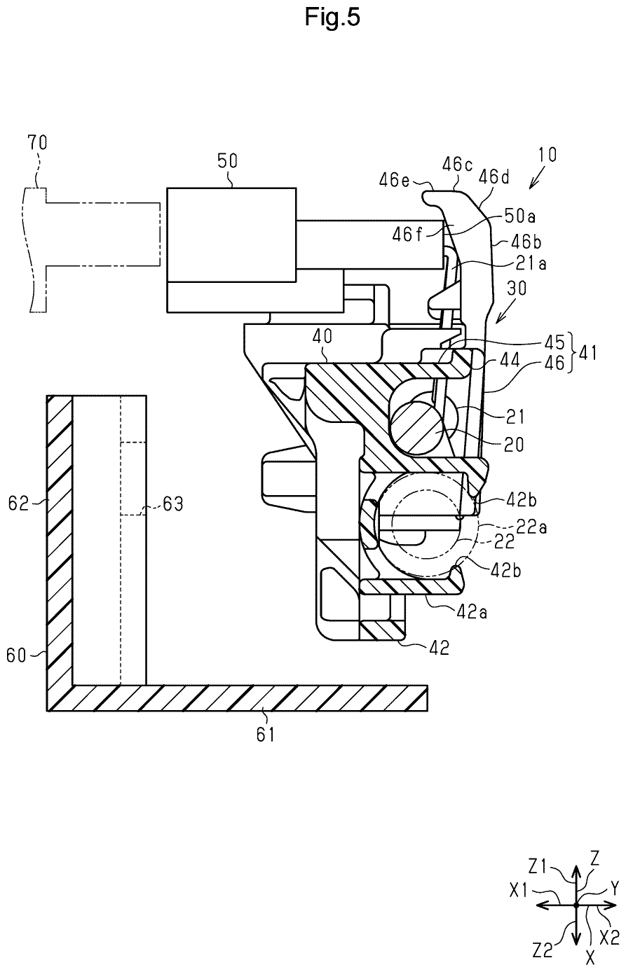

As shown in FIGS. 1 to 4, the connectors 50 are provided above (in the upward direction Z1 with respect to) the protector body 41. The two connectors 50 are fixed at positions above (in the upward direction Z1 with respect to) the protector body 41 and spaced apart from each other along the second axis Y. Each connector 50 is configured to receive a mating connector 70 (see FIGS. 5 to 7) inserted from the first direction X1.

### Structure of the Protector Body 41

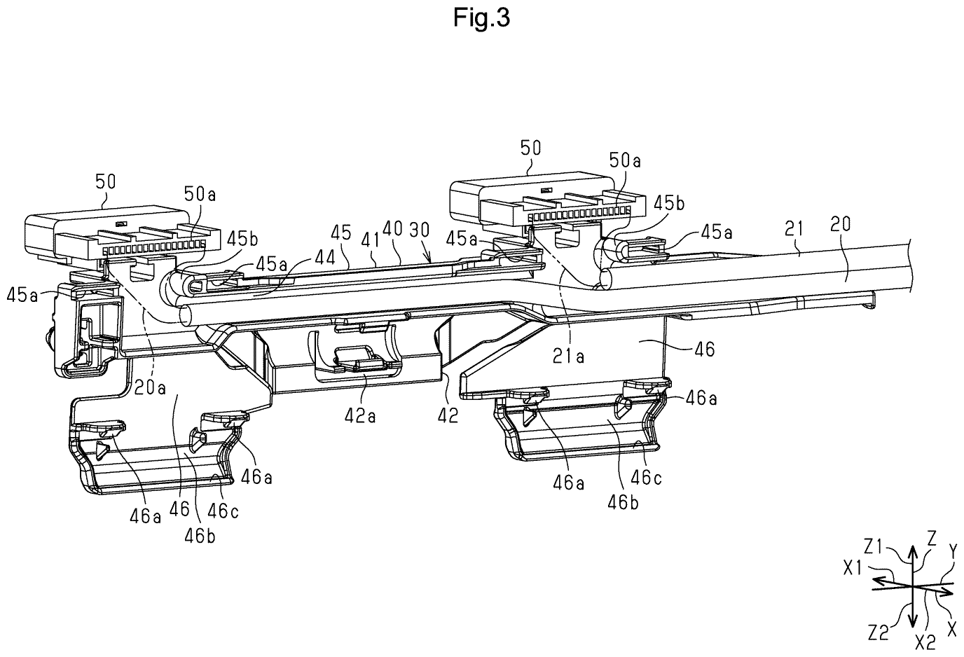

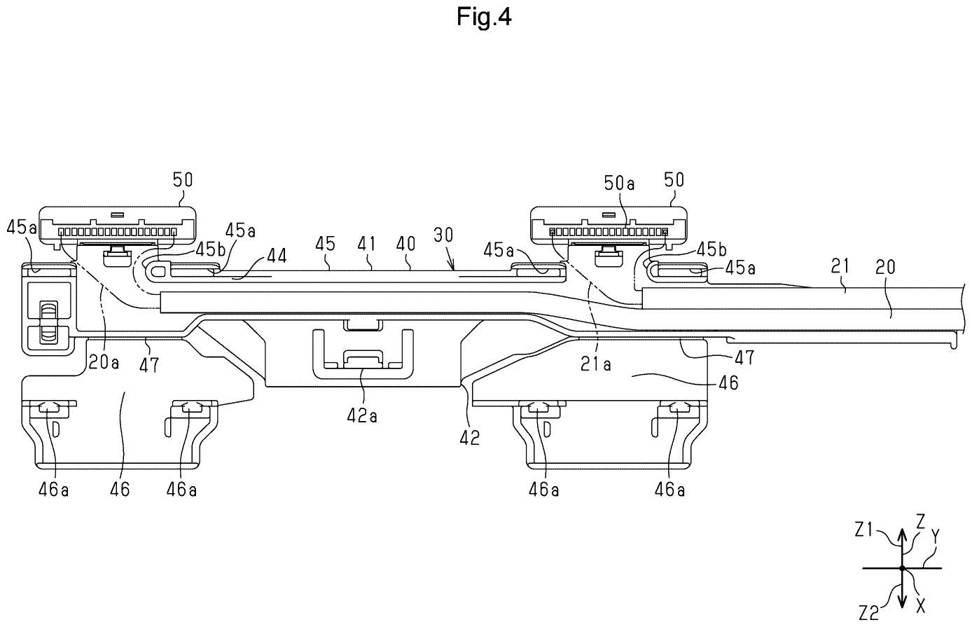

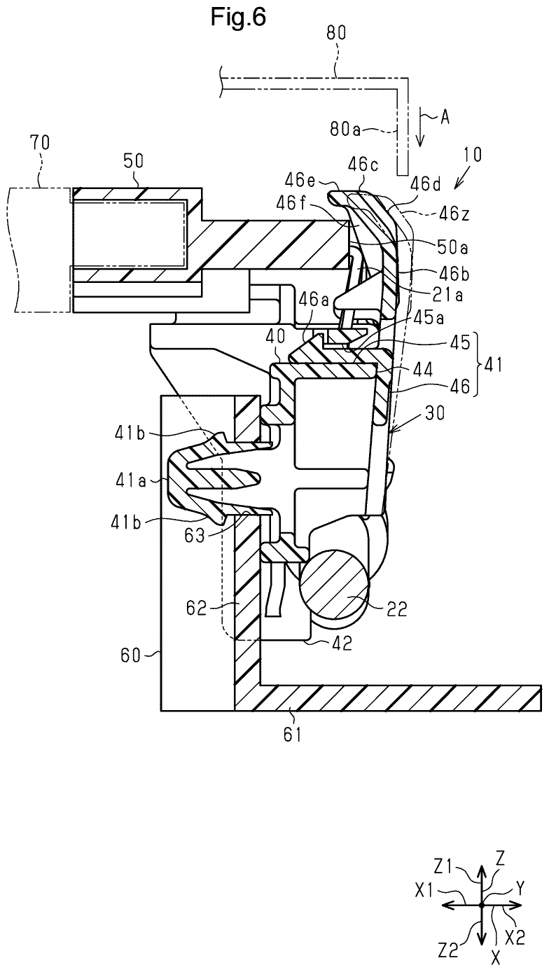

As shown in FIGS. 3 to 5, the protector body 41 includes a main body portion 45 and cover portions 46. The main body portion 45 includes openings 44 that open in the first opposite direction X2 and accommodate the electric wire bundles 20, 21. The cover portions 46 close the openings 44. The cover portions 46 of the present embodiment are coupled to the lower end of the main body portion 45 by thin hinge portions 47 (see FIG. 4) at two positions corresponding to the connectors 50 so as to be rotatable from an open state to a closed state. The cover portions 46 close the openings 44 when in the closed state. The cover portions 46 each include an engagement tab 46a, which is engaged with an engagement hole 45a provided in the main body portion 45 when the cover portion 46 is in the closed state as shown in FIG. 6. FIGS. 1, 2, 5, 6, and 7 illustrate the cover portion 46 in the closed state, and FIGS. 3 and 4 illustrate the cover portion 46 in the open state.

In addition, the main body portion 45 includes connecting portions 45b (see FIGS. 3 and 4), which open in the upward direction Z1 at two positions corresponding to the connectors 50. Multiple electric wires 20a, 21a, which form the electric wire bundles 20, 21, extend from within the protector body 41 through the connecting portions 45b to be connected to ends 50a in the first opposite direction X2 of the connectors 50. The electric wire bundles 20, 21 are bundled, for example, by tape wrapping or the like, and in the region passing through the connecting portion 45b, the individual electric wires 20a, 21a are separated from one another. The electric wires 20a, 21a are connected to the ends 50a in the first opposite direction X2 of the connectors 50 in a state of being arranged along the second axis Y. In FIGS. 3 and 4, the electric wires 20a, 21a are schematically illustrated by the long-dash double-short-dash lines. Specifically, in FIGS. 3 and 4, only the outermost contours of the electric wires 20a, 21a are illustrated. In other words, the ranges through which the electric wires 20a and 21a extend are indicated by the long-dash double-short-dash lines.

As shown in FIGS. 2 and 6, the protector body 41 includes fixing portions 41a fixed to the side wall 62 of the attachment member 60 (see FIG. 1) in the first direction X1, which intersects with the side wall 62. The fixing portions 41a are spaced apart in the downward direction Z2 from the connectors 50. The fixing portions 41a are provided at two positions that correspond to the connectors 50 and correspond to the fixing holes 63 of the side walls 62. As shown in FIG. 6, each fixing portion 41a includes two fixing tabs 41b that protrude in the first direction X1 and spread outward from each other as they extend in the first opposite direction X2. When the fixing portion 41a is inserted into the fixing hole 63 in the first direction X1, the fixing tabs 41b engage with the edge of the fixing hole 63, so that the fixing portion 41a is fitted into the fixing hole 63.

### Configuration of the Downward Extending Portion 42

As shown in FIG. 4, the downward extending portion 42 is disposed below the protector body 41 in the downward direction Z2 between the two connectors 50. The downward extending portion 42 extends below the protector body 41 in the downward direction Z2. The downward extending portion 42 includes an additional electric wire holding portion 42a capable of holding the additional electric wire bundle 22 (see FIGS. 1 and 5).

As shown in FIG. 5, the additional electric wire holding portion 42a has a pair of holding tabs 42b capable of holding the additional electric wire bundle 22. The additional electric wire bundle 22 includes an outer sheath 22a that is gripped by the pair of holding tabs 42b, thereby securing the additional electric wire bundle 22 to the additional electric wire holding portion 42a.

### Detailed Structure of the Cover Portions 46

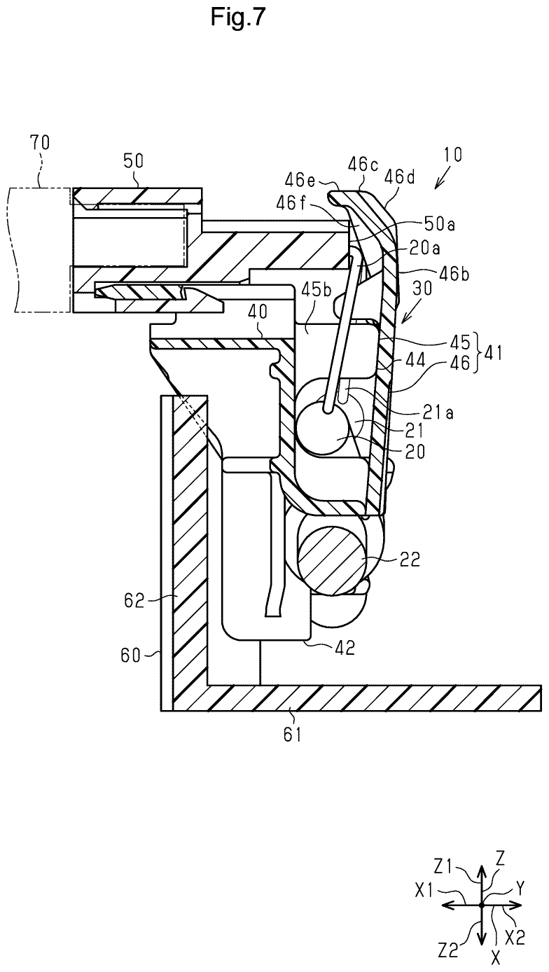

As shown in FIG. 7, each cover portion 46 includes a rear covering portion 46b and an upper covering portion 46c, which are located above (in the upward direction Z1 with respect to) the connecting portions 45b. The rear covering portion 46b covers the side in the first opposite direction X2 of the electric wires 20a, 21a. The upper covering portion 46c covers the side in the upward direction Z1 of the electric wires 20a, 21a.

Also, the cover portions 46 each include an inclined portion 46d at the end in the first opposite direction X2 of the upper edge of the cover portion 46. The inclined portion 46d extends in the first direction X1 while being inclined obliquely in the upward direction Z1. In the present embodiment, a part of the upper covering portion 46c covering the side in the upward direction Z1 of the electric wires 20a, 21a form a part of the inclined portion 46d.

The upper covering portion 46c extends farther in the first direction X1 than the end 50a in the first opposite direction X2 of the connector 50. Specifically, the upper covering portion 46c includes an extension 46e extending from the upper edge of the inclined portion 46d in the first direction X1. The extension 46e extends in the first direction X1 beyond the end 50a in the first opposite direction X2 of the connector 50.

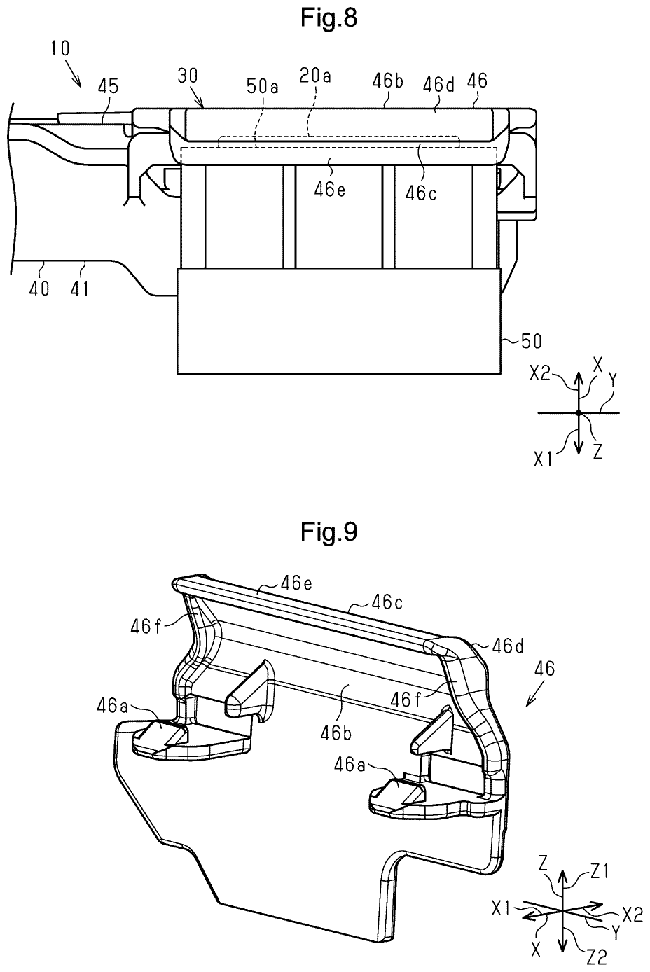

Further, as shown in FIG. 8, the upper covering portion 46c covers all of the electric wires 20a when viewed from a position in the upward direction Z1. Specifically, the electric wires 20a are connected to the end 50a in the first opposite direction X2 of the connector 50 in a state of being arranged along the second axis Y. The upper covering portion 46c covers all of the electric wires 20a arranged along the second axis Y. In FIG. 8, the electric wires 20a, aligned along the second axis Y, are schematically illustrated by broken lines. In addition, although FIG. 8 illustrates the upper covering portion 46c that covers the electric wires 20a in the first electric wire bundle 20 of the two electric wire bundles 20, 21, the upper covering portion 46c that covers the electric wires 21a in the second electric wire bundle 21 has the same configuration.

As shown in FIG. 9, the cover portion 46 includes reinforcing ribs 46f extending across the rear covering portion 46b and the upper covering portion 46c. The reinforcing ribs 46f are provided at the opposite ends of the cover portion 46 along the second axis Y.

### Operation of the Wire Harness 10

Operation of the wire harness 10 will now be described.

As shown in FIG. 7, the sides in the first opposite direction X2 of the electric wires 20a, 21a are covered by the rear covering portion 46b. Also, the sides in the upward direction Z1 of the electric wires 20a, 21a are covered by the upper covering portion 46c. Accordingly, the electric wires 20a, 21 are protected.

Further, in the protector 30, for example, when the connector 50 is urged in the first opposite direction X2 by the mating connector 70, the section above (in the upward direction Z1 with respect to) the fixing portion 41a may be urged in the first opposite direction X2 as shown in FIG. 6. In such a case, due to play or looseness between the fixing portion 41a and the fixing hole 63, the protector 30 may tilt about the fixing portion 41a. In FIG. 6, the long-dash double-short-dash lines indicate the cover portion 46z when the protector 30 tilts about the fixing portion 41a. The side in the upward direction Z1 of the protector 30 is covered by, for example, a lid 80, which forms a part of the housing of the cell pack. Even when the lid 80 is placed from a position in the upward direction Z1 toward the area in the downward direction Z2 (see arrow A), for example, a flange 80a extending in the downward direction Z2 from the edge of the lid 80 is prevented from striking the electric wires 20a and 21a.

### Advantages of the Present Embodiment

The above-described embodiment has the following advantages.
(1) The cover portion 46, which closes the opening 44, includes the rear covering portion 46b, which covers the side in the first opposite direction X2 of the electric wires 20a, 21a, and the upper covering portion 46c, which covers the side in the upward direction Z1 of the electric wires 20a, 21a. This configuration covers the electric wires 20a, 21a while avoiding an increase in the number of components. In other words, since the cover portion 46 closes the opening 44 that opens in the first opposite direction X2 of the main body portion 45 of the protector body 41, the number of components is not increased as compared with a configuration that separately includes a dedicated cover member for protecting the electric wires 20a, 21a. The rear covering portion 46b prevents foreign matter from striking the electric wires 20a, 21b from the first opposite direction X2. Further, the upper covering portion 46c prevents foreign matter from striking the electric wires 20a, 21a from above (from the area in the upward direction Z1). Further, the rear covering portion 46b prevents the electric wires 20a, 21a from significantly projecting in the first opposite direction X2. Further, the upper covering portion 46c prevents the electric wires 20a, 21a from significantly projecting in the upward direction Z1.
(2) The cover portion 46 includes the inclined portion 46d at the end in the first opposite direction X2 of the upper edge of the cover portion 46. The inclined portion 46d extends in the first direction X1 while being inclined obliquely in the upward direction Z1. Therefore, it is possible to guide foreign matter that has struck the end in the first opposite direction X2 of the upper edge of the cover portion 46 from above (from the area in the upward direction Z1) to move in the first opposite direction X2.
(3) The upper covering portion 46c extends farther in the first direction X1 than the end 50a in the first opposite direction X2 of the connector 50. Therefore, even when the protector body 41 is inclined, it is possible to prevent foreign matter from striking the electric wires 20a, 21a from above (from the area in the upward direction Z1). Specifically, for example, in a configuration in which the upper covering portion 46c does not extend farther in the first direction X1 than the end 50a of the connector 50, tilting of the protector body 41 may cause foreign matter from above (from the area in the upward direction Z1) to pass through between the connector 50 and the upper covering portion 46c. The above-described configuration prevents such passage of foreign matter.
(4) Since the upper covering portion 46c covers all of the electric wires 20a, 21a when viewed from above (from a position in the upward direction Z1), it is possible to prevent foreign matter from striking any of the electric wires 20a, 21a from above (form the area in the upward direction Z1).
(5) The cover portion 46 includes reinforcing ribs 46f extending across the rear covering portion 46b and the upper covering portion 46c. Therefore, for example, even when a foreign matter strikes the cover portion 46 from above (from the area in the upward direction Z1), the cover portion 46 is unlikely to be deformed. Therefore, the electric wires 20a, 21a are reliably protected.
(6) The cover portion 46 is coupled to the lower end of the main body portion 45 by the thin hinge portion 47 so as to be rotatable from the open state to the closed state. Therefore, for example, the number of components is reduced as compared with a case in which the cover portion 46 is a separate component from the main body portion 45.

### Modifications

The above-described embodiment may be modified as follows. The above-described embodiment and the following modifications can be combined if the combined modifications remain technically consistent with each other.

In the above-described embodiment, the cover portion 46 includes the inclined portion 46d, which is extends in the first direction X1 while being inclined obliquely in the upward direction Z1, at the end in the first opposite direction X2 of the upper edge of the cover portion 46. However, the present disclosure is not limited thereto, and the inclined portion 46d may be omitted.

In the above-described embodiment, a part of the upper covering portion 46c covering the side in the upward direction Z1 of the electric wires 20a, 21a form a part of the inclined portion 46d. However, the present disclosure is not limited thereto. For example, a part of the rear covering portion 46b, which covers the side in the first opposite direction X2 of the electric wires 20a, 21a may form a part of the inclined portion 46d. Further, for example, the inclined portion 46d may be provided between the upper covering portion 46c and the rear covering portion 46b.

In the above-described embodiment, the upper covering portion 46c extends farther in the first direction X1 than the end 50a in the first opposite direction X2 of the connector 50. However, the present disclosure is not limited thereto. The upper covering portion 46c does not necessarily need to extend farther in the first direction X1 than the end 50a of the connector 50.

In the above-described embodiment, the upper covering portion 46c covers all of the electric wires 20a, 21a when viewed from a position in the upward direction Z1. However, the present disclosure is not limited thereto. For example, the upper covering portion 46c may cover only part of the electric wires 20a, 21a.

In the above-described embodiment, the cover portion 46 includes reinforcing ribs 46f extending across the rear covering portion 46b and the upper covering portion 46c. However, the present disclosure is not limited thereto. The cover portion 46 does not necessarily need to have the reinforcing ribs 46f.

In the above-described embodiment, the cover portion 46 is configured to be coupled to the lower end of the main body portion 45 by the thin hinge portion 47 so as to be rotatable from the open state to the closed state. However, the present disclosure is not limited thereto. For example, the cover portion 46 may be a separate component from the main body portion 45.

In the above-described embodiment, the protector 30 includes two connectors 50. However, the present disclosure is not limited thereto. For example, the protector 30 may include only one connector 50 or may include three or more connectors 50. Further, the number of the electric wire bundles 20, 21 held by the protector 30 may be changed in accordance with the number of the connectors 50.

In the above-described embodiment, the protector 30 includes the downward extending portion 42, and the downward extending portion 42 includes the additional electric wire holding portion 42a, capable of holding the additional electric wire bundle 22. However, the present disclosure is not limited thereto. For example, the protector 30 may omit the additional electric wire holding portion 42a, or may omit the downward extending portion 42. Further, the wire harness 10 may omit the additional electric wire bundle 22.

In the above-described embodiment, the fixing portions 41a are provided at two positions corresponding to the connectors 50. However, the present disclosure is not limited thereto. For example, the protector 30 may include only one fixing portion 41a or may include three or more fixing portions 41a.

For example, in the non-limiting embodiments illustrated in FIGS. 1 to 3, the XY plane may be referred to as a reference plane. The XY plane may be substantially parallel to the ground on which the vehicle equipped with the wire harness 10 travels, and may be a horizontal plane.

For example, as illustrated in FIGS. 1 to 3, the electric wire bundle 20, 21 may include a first length portion that extends substantially parallel to the reference plane XY.

In the non-limiting embodiment illustrated in FIG. 5, the protector body 41 may include or define a wire routing groove/pocket for accommodating and routing a first length portion of the electric wire bundles 20, 21. The wire routing groove/pocket may extend substantially parallel to a reference plane, such as the XY plane, and may include a lower wire support surface configured to support the first length portion of the electric wire bundles 20, 21 from below, an upper wire protection surface configured to cover the first length portion of the electric wire bundles 20, 21 from above, a lateral protection surface configured to cover the first length portion of the electric wire bundles 20, 21 from the side opposite to the openings 44 so that the first length portion of the electric wire bundles 20, 21 does not fall out sideways, and the openings 44 configured to allow the first length portion of the electric wire bundles 20, 21 to be placed in the wire routing groove/pocket from the outside of the protector body 41.

The upper wire protection surface of the wire routing groove/pocket may include the connecting portions 45b at one or more predetermined position(s) corresponding to the end(s) of one or more electric wires 20a, 21a of the electric wire bundles 20, 21. The connecting portions 45b may be referred to as or function as a wire withdrawal window for drawing out the one or more electric wires 20a, 21a from the inside to the outside of the wire routing groove/pocket.

In the non-limiting embodiment illustrated in FIG. 6, the protector body 41 may include the cover portions 46 hingedly connected to the wire routing groove/pocket. The cover portion 46 may be a flap configured to cover the upper wire protection surface of the wire routing groove/pocket from above and the openings 44 from the side at the predetermined position(s) of the wire routing groove/pocket.

As shown in FIGS. 1 to 4, in the cover portion 46, the width of the rear covering portion 46b and the upper covering portion 46c in the direction of the second axis Y is greater than the arrangement width of the electric wires 20a aligned along the second axis Y and the width of the connector 50 in the direction of the second axis Y. With this configuration, the end portions of the electric wires 20a are not exposed to the outside, and the risk of foreign matter intrusion is further reduced.

As shown in FIGS. 3 and 4, the distance between the pair of engagement tabs 46a in the direction of the second axis Y in the cover portion 46 is greater than the arrangement width of the multiple electric wires 20a aligned along the second axis Y. When the cover portion 46 is in the closed state, the multiple electric wires 20a are positioned between the pair of engagement tabs 46a. This positional arrangement helps prevent the electric wires 20a from protruding or shifting outward.

As shown in FIGS. 2, 3, 6, and 9, a pair of protrusions is formed between the pair of engagement tabs 46a and the rear covering portion 46b. The width of the pair of protrusions in the direction of the second axis Y is greater than the arrangement width of the multiple electric wires 20a aligned along the second axis Y. When the cover portion 46 is in the closed state, the pair of protrusions are positioned between the end 50a of the connector 50 in the first opposite direction X2 and the pair of engagement tabs 46a. The electric wires 20a are positioned between the pair of protrusions. This configuration further reduces the risk of the electric wires 20a protruding outward or becoming exposed.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A wire harness, comprising:
an electric wire bundle including multiple electric wires;
a protector body that holds the electric wire bundle; and
a connector provided in an upward direction with respect to the protector body and configured to be fitted to a mating connector from a first direction intersecting with the upward direction, wherein
the protector body includes:
a main body portion provided with an opening that opens in a first opposite direction opposite to the first direction, the electric wire bundle being accommodated in the body portion; and
a cover portion that closes the opening,
the main body portion includes a connecting portion that opens in the upward direction,
the electric wires extend from within the protector body through the connecting portion to be connected to an end in the first opposite direction of the connector, and
the cover portion includes:
a rear covering portion located in the upward direction with respect to the connecting portion, the rear covering portion covering a side in the first opposite direction of the electric wires; and
an upper covering portion that covers a side in the upward direction of the electric wires.

2. The wire harness according to claim 1, wherein the cover portion includes an inclined portion at an end in the first opposite direction of an upper edge of the cover portion, the inclined portion extending in the first direction while being inclined obliquely in the upward direction.

3. The wire harness according to claim 1, wherein the upper covering portion extends farther in the first direction than an end in the first opposite direction of the connector.

4. The wire harness according to claim 1, wherein the upper covering portion covers all of the electric wires when viewed from a position in the upward direction.

5. The wire harness according to claim 1, wherein the cover portion includes a reinforcing rib extending across the rear covering portion and the upper covering portion.

6. The wire harness according to claim 1, wherein the cover portion is coupled to a lower end of the main body portion by a thin hinge portion so as to be rotatable from an open state to a closed state, the cover portion closing the opening when in the closed state.
